(19) United States
(12) Patent Application Publication
(10) Pub. No.: US 2024/0077567 A1
(43) Pub. Date: Mar. 7, 2024

(54) AUXILIARY POSITIONING SYSTEM AND METHOD

(71) Applicants: INVENTEC (PUDONG) TECHNOLOGY CORPORATION, Shanghai (CN); INVENTEC CORPORATION, Taipei City (TW)

(72) Inventors: Encheng LIOU, Taipei City (TW); Lien-Feng CHEN, Taipei City (TW); Chang-Han YANG, Taipei City (TW)

(73) Assignees: INVENTEC (PUDONG) TECHNOLOGY CORPORATION, Shanghai (CN); INVENTEC CORPORATION, Taipei City (TW)

(21) Appl. No.: 18/121,546

(22) Filed: Mar. 14, 2023

(30) Foreign Application Priority Data
Sep. 6, 2022 (CN) 202211085310.9

(51) Int. Cl. G01S 5/00; G01S 5/02

(52) U.S. Cl. CPC G01S 5/0027; G01S 5/0205; G01S 2205/008; G01S 2205/02

(57) ABSTRACT

An auxiliary positioning system includes an ultra-wideband (UWB) element, and a service management and orchestration (SMO) apparatus and a near-real time ran intelligent controller (Near-RT RIC) connected with each other, wherein the SMO apparatus includes a non-real time ran intelligent controller (Non-RT RIC). The UWB element is connected to a second application disposed at at least one of the SMO apparatus, the Near-RT RIC and the Non-RT RIC through a first application. The UWB element is configured to output positioning information of a user device to the second application through the first application.

### CROSS-REFERENCE TO RELATED APPLICATIONS

This non-provisional application claims priority under 35 U.S.C. § 119(a) on Patent Application No(s). 202211085310.9 filed in China on Sep. 6, 2022, the entire contents of which are hereby incorporated by reference.

### BACKGROUND

### 1. Technical Field

This disclosure relates to an auxiliary positioning system and method.

### 2. Related Art

When the existing 5G technology manages base stations and terminal devices (mobile phones/IoT devices), the design of the positioning mechanism of the existing 4G or 5G communication standards and transmission protocols mainly refers to the wireless signal parameters of the terminal devices (for example, parameters of incident angle, reflection angle, etc.), and executes the auxiliary determination of indoor positioning based on the positioning signal of the base station or terminal device. However, in a specific field, such as indoor positioning in an intelligent factory, it is often limited by the error of indoor positioning, thus it is difficult to accurately determine the position and error value of the terminal device.

Considering the application scenarios of 5G private network applied to intelligent factories, under the condition that the cost of software and hardware are more strictly limited, if the existing 5G transmission standards and technical solutions are adopted, it might be difficult to further improve the performance of 5G private network management for indoor positioning or other applications.

### SUMMARY

Accordingly, this disclosure provides an auxiliary positioning system and method for solving the above issues.

According to one or more embodiment of this disclosure, an auxiliary positioning system includes a service management and orchestration apparatus including a non-real-time radio access network intelligent controller, a near-real-time radio access network intelligent controller connected to the service management and orchestration apparatus, and an ultra-wideband element connected to a second application disposed at at least one of the service management and orchestration apparatus, the non-real-time radio access network intelligent controller and the near-real-time radio access network intelligent controller through a first application. The ultra-wideband element is configured to output positioning information about the user device to the second application through the first application.

According to one or more embodiment of this disclosure, an auxiliary positioning method includes: connecting the ultra-wideband element to the second application disposed at at least one of the service management and orchestration apparatus, the non-real-time radio access network intelligent controller and the near-real-time radio access network intelligent controller through the first application; and outputting the positioning information about the user device to the second application through the first application by the ultra-wideband element.

In view of the above description, according to the auxiliary positioning system and method of one or more embodiment of this disclosure, the service management and orchestration apparatus, the non-real-time radio access network intelligent controller and/or the near-real-time radio access network intelligent controller can effectively improve the accuracy of 5G private network in indoor positioning based on the positioning information of the user device. Therefore, the service management and orchestration apparatus, the non-real-time radio access network intelligent controller and/or the near-real-time radio access network intelligent controller can adjust the software/hardware/firmware parameters of the base station according to the positioning information to further improve the wireless transmission performance between the base station and the user device (stability/delay/throughput, etc.).

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram of the auxiliary positioning system according to an embodiment of the present disclosure;

FIG. 2 is a flow chart of the auxiliary positioning method according to an embodiment of the present disclosure;

FIG. 3 is a block diagram of the auxiliary positioning system according to another embodiment of the present disclosure;

FIG. 4 is a flow chart of the step S23 in detail of the auxiliary positioning method shown in FIG. 2 according to an embodiment of the present disclosure;

FIG. 5 is a block diagram of the auxiliary positioning system according to still another embodiment of the present disclosure;

FIG. 6 is a flow chart of the step S23 in detail of the auxiliary positioning method shown in FIG. 2 according to another embodiment of the present disclosure;

FIG. 7 is a flow chart of the step S23 in detail of the auxiliary positioning method shown in FIG. 2 according to still another embodiment of the present disclosure;

FIG. 8 is a block diagram of the auxiliary positioning system according to yet still another embodiment of the present disclosure; and

FIG. 9 is a flow chart of the method of applying the ultra-wideband element according to an embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

The auxiliary positioning system and method according to one or more embodiments of the present disclosure may be applied to the 5G open radio access network (O-RAN) to assist the open radio access network used in specific fields (for example, indoor positioning of intelligent factories), to obtain the positioning of the user device in a more accurate way.

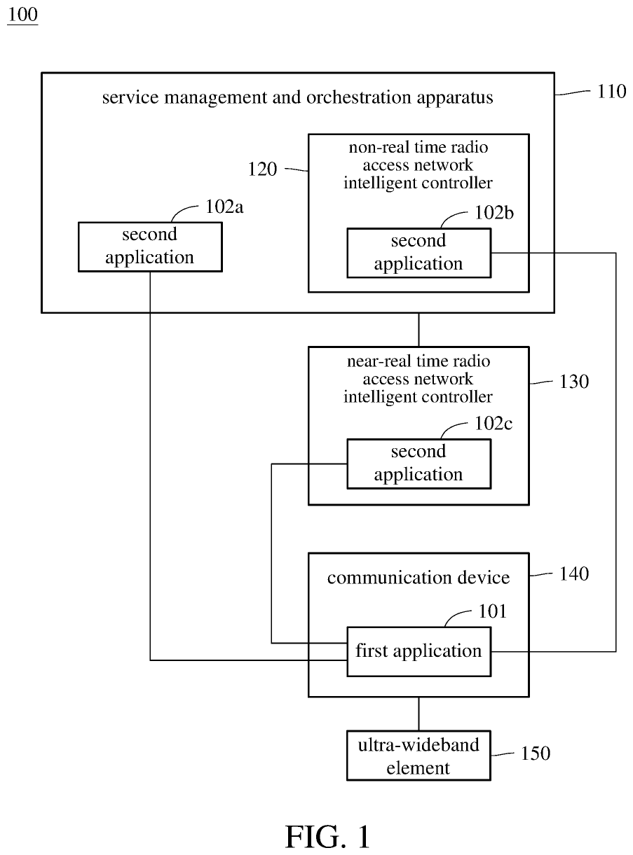

Please refer to FIG. 1 which is a block diagram of the auxiliary positioning system according to an embodiment of the present disclosure. As shown in FIG. 1, the auxiliary positioning system 100 includes a service management and orchestration (SMO) apparatus 110, a near-real time radio access network intelligent controller 130 (Near-Real Time RAN Intelligent Controller, Near-RT RIC) and an ultra-wideband (UWB) element 150. The service management and orchestration apparatus 110 includes a non-real time radio access network intelligent controller 120 (Non-Real Time RAN Intelligent Controller, Non-RT RIC). The near-real time radio access network intelligent controller 130 is connected to the service management and orchestration apparatus 110.

It should be noted that, the ultra-wideband element 150 may be an independent element installed on the communication device 140 to obtain the positioning information about the position of the user device. The ultra-wideband element 150 may also be an expansion module (or an extension device of the expansion module) installed on the communication device 140. The ultra-wideband element 150 may be bound to the communication device 140, and the signal output by the ultra-wideband element 150 may contain the association between the hardware serial number of the ultra-wideband element 150 and the serial number of the communication device 140.

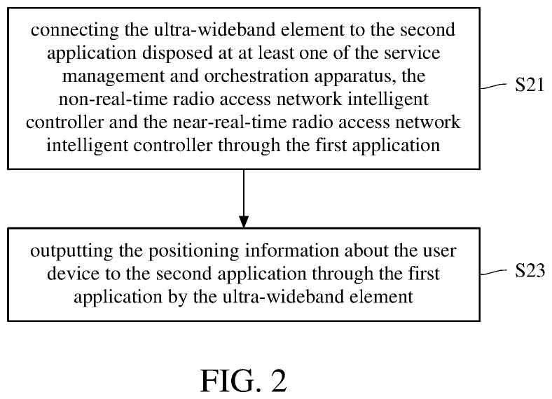

To further illustrate the operation method of the auxiliary positioning system of the present disclosure, please refer to FIG. 2 along with FIG. 1, wherein FIG. 2 is a flow chart of the auxiliary positioning method according to an embodiment of the present disclosure. As shown in FIG. 2, the auxiliary positioning method according to an embodiment of the present disclosure includes: step S21: connecting the ultra-wideband element to the second application disposed at at least one of the service management and orchestration apparatus, the non-real-time radio access network intelligent controller and the near-real-time radio access network intelligent controller through the first application; and step S23: outputting the positioning information about the user device to the second application through the first application by the ultra-wideband element.

In step S21, the ultra-wideband element 150 is connected to at least one of the second application 102a of the service management and orchestration apparatus 110, the second application 102b of the non-real-time radio access network intelligent controller 120 and the second application 102c of the near-real-time radio access network intelligent controller 130 through the first application 101 of the communication device 140. In other words, the first application 101 may be connected to the second applications 102a, 102b and 102c at the same time, or may be connected to one or two of the second applications 102a, 102b and 102c. The second application 102b may be an rAPP, and the second application 102c may be an xAPP. The above step may be executed by setting one or more computers.

In step S23, the ultra-wideband element 150 outputs the positioning information about the user device to the second application connected to the first application 101 through the first application 101 of the communication device 140. Therefore, the service management and orchestration apparatus 110, the non-real-time radio access network intelligent controller 120 and/or the near-real-time radio access network intelligent controller 130 may effectively improve the accuracy of 5G private network in indoor positioning based on the positioning information of the user device, and may further adjust the parameters of the service management and orchestration apparatus 110, the non-real-time radio access network intelligent controller 120 and/or the near-real-time radio access network intelligent controller 130 during subsequent maintenance to improve the performance of 5G private network.

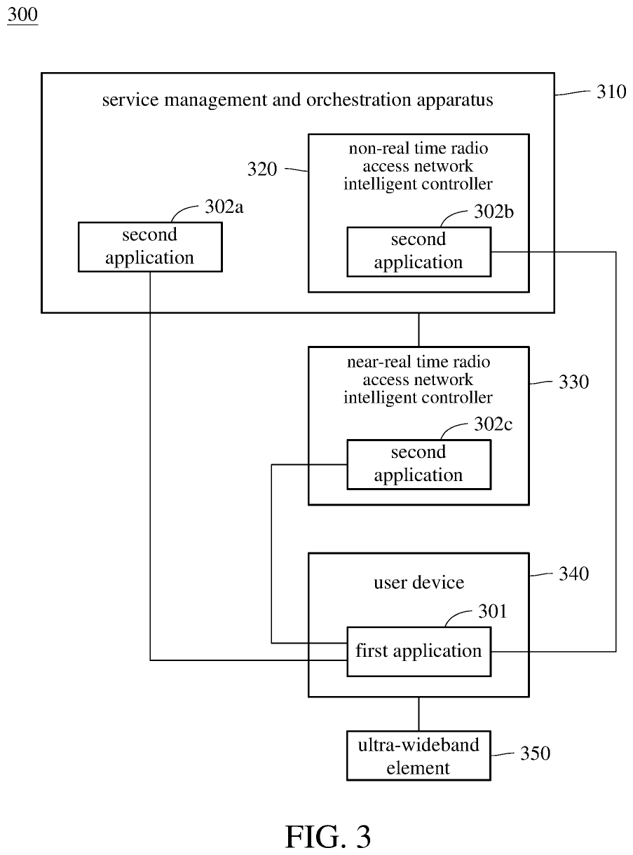

Please refer to FIG. 3 which is a block diagram of the auxiliary positioning system according to another embodiment of the present disclosure. Since the auxiliary positioning system 300 illustrated in FIG. 3 is similar to the auxiliary positioning system 100 illustrated in FIG. 1, the repeated description is omitted herein. The difference in the systems between FIG. 3 and FIG. 1 is that, the first application 301 shown in FIG. 3 is installed on the user device 340. In other words, the communication device 140 shown in FIG. 1 may be the user device 340 shown in FIG. 3, wherein the user device 340 is preferably a mobile terminal device, such as a smart phone, a tablet computer and a notebook computer, and the present disclosure is not limited thereto.

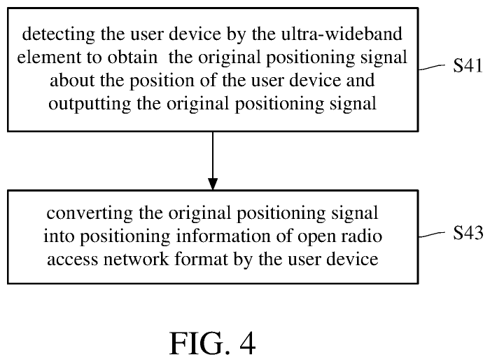

To further illustrate the operation method of the auxiliary positioning system 300 shown in FIG. 3, please refer to FIG. 4 together, wherein FIG. 4 is a flow chart of the step S23 in detail of the auxiliary positioning method shown in FIG. 2 according to an embodiment of the present disclosure. As shown in FIG. 4, step S23 in FIG. 2 includes: step S41: detecting the user device by the ultra-wideband element to obtain the original positioning signal about the position of the user device and outputting the original positioning signal; and step S43: converting the original positioning signal into positioning information of open radio access network format by the user device.

In step S41, the ultra-wideband element 350 is configured to sense the position of the user device 340 to generate the original positioning signal (ultra-wideband signal) about the user device 340, and output the original positioning signal to the user device 340. In step S43, the user device 340 converts the original positioning signal into the positioning information of open radio access network format.

In short, in steps S41 and S43, the user device 340 may obtain the original positioning signal about the position of the user device 340 from the ultra-wideband element 350, and convert the original positioning signal into the positioning information of open radio access network format, to make the second application receive the positioning information of open radio access network format (instead of other formats).

Further, in this embodiment, the user device 340 may be established with independent transmission channels with the service management and orchestration apparatus 310, the non-real-time radio access network intelligent controller 320 and/or the near-real-time radio access network intelligent controller 330, to transmit positioning information to corresponding second application.

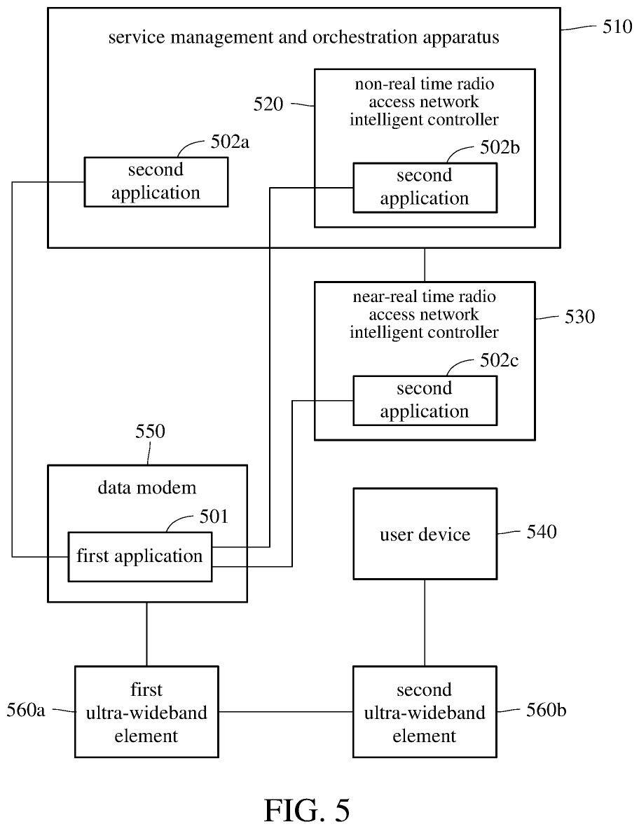

Please refer to FIG. 5 which is a block diagram of the auxiliary positioning system according to still another embodiment of the present disclosure. Since the auxiliary positioning system 500 illustrated in FIG. 5 is similar to the auxiliary positioning system 100 illustrated in FIG. 1, the repeated description is omitted herein. The difference in the system between FIG. 5 and FIG. 1 is that, the auxiliary positioning system 500 shown in FIG. 5 further comprises a data modem 550 which is connected to the user device 540 through wireless internet (WiFi). Further, the data modem 550 and the user device 540 may communicate with each other according to the transmission control protocol/internet protocol (TCP/IP).

The first application 501 is installed on the data modem 550, and the above ultra-wideband element is a first ultra-wideband element 560a installed on the data modem 550. In other words, the communication device 140 shown in FIG. 1 may be the data modem 550 shown in FIG. 5, and the ultra-wideband element 150 shown in FIG. 1 may be the first ultra-wideband element 560a shown in FIG. 5. In addition, the first ultra-wideband element 560a is further connected to the second ultra-wideband element 560b installed on the user device 540. An independent transmission channel may be established between the first application 501 of the modem 550 and the second application 502a of the service management and orchestration apparatus 510, which is established according to the network configuration protocol (Netconf).

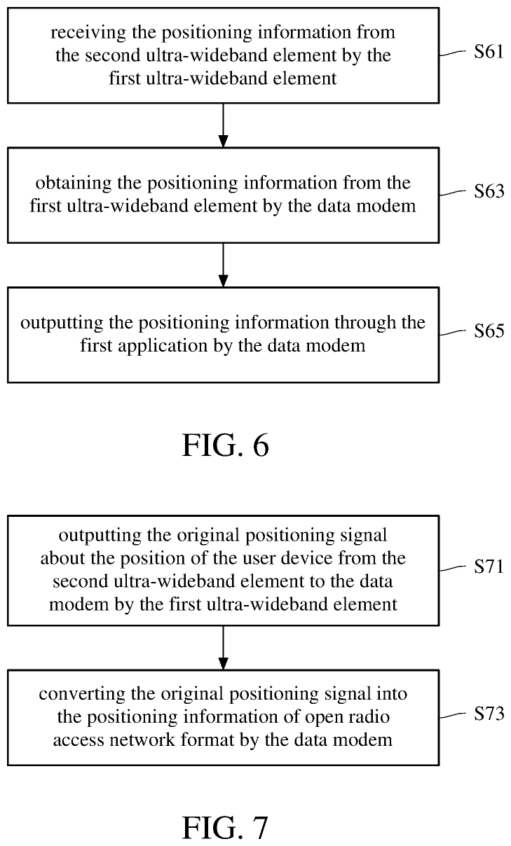

To further illustrate the operation method of the auxiliary positioning system 500 shown in FIG. 5, please refer to FIG. 6 together, wherein FIG. 6 is a flow chart of the step S23 in detail of the auxiliary positioning method shown in FIG. 2 according to another embodiment of the present disclosure. As shown in FIG. 6, step S23 in FIG. 2 includes: step S61: receiving the positioning information from the second ultra-wideband element by the first ultra-wideband element; step S63: obtaining the positioning information from the first ultra-wideband element by the data modem; and step S65: outputting the positioning information through the first application by the data modem.

In step S61, the first ultra-wideband element 560a receives the positioning information about the user device 540 from the second ultra-wideband element 560b. In other words, the second ultra-wideband element 560b is configured to generate the positioning information of the user device 540 and output the positioning information to the first ultra-wideband element 560a. In addition, the first ultra-wideband element 560a may receive the positioning information about the user device 540 from the second ultra-wideband element 560b according to the transmission control protocol/internet protocol (TCP/IP).

In steps S63 and S65, the first application 501 of the data modem 550 receives the positioning information about the user device 540 through the first ultra-wideband element 560a, and the data modem 550 outputs the positioning information to the second application through the first application 501. For example, if the first application 501 is connected to the second applications 502a and 502b, the first application 501 may output the positioning information to the second applications 502a and 502b. In other words, the subject to which the first application 501 outputs the positioning information is the second application connected to the first application 501. In addition, the first ultra-wideband element 560a may also be configured to generate the positioning information of the data modem 550. Therefore, the data modem 550 may output the positioning information of the user device 540 along with the positioning information of the data modem 550 to the second application.

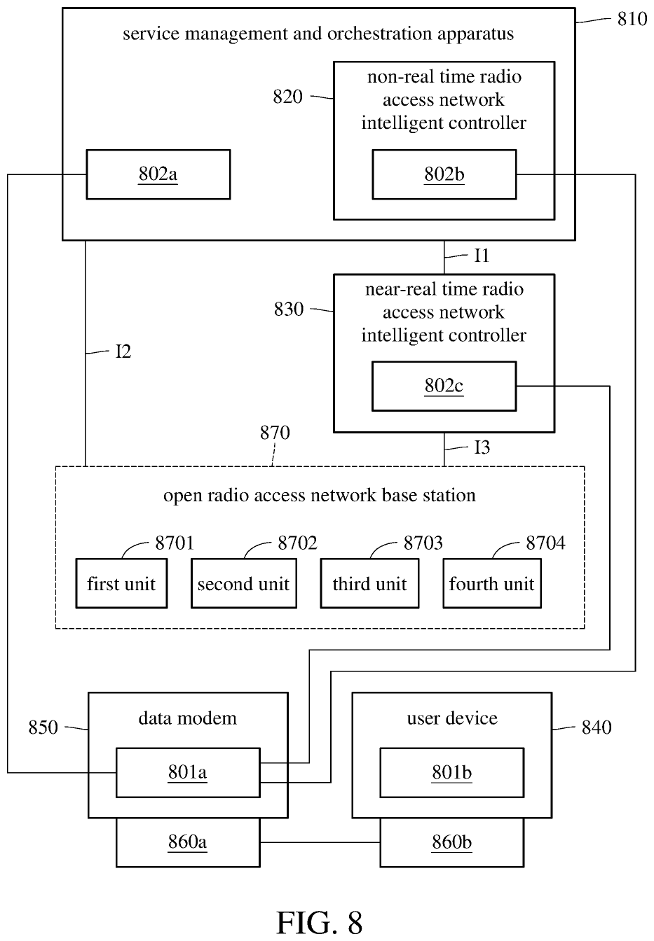

Please refer to FIG. 7 along with FIG. 5, wherein FIG. 7 is a flow chart of the step S23 in detail of the auxiliary positioning method shown in FIG. 2 according to still another embodiment of the present disclosure. As shown in FIG. 7, step S23 in FIG. 2 includes: step S71: outputting the original positioning signal about the position of the user device from the second ultra-wideband element to the data modem by the first ultra-wideband element; and step S73: converting the original positioning signal into the positioning information of open radio access network format by the data modem.

In step S71, the first ultra-wideband element 560a outputs the original positioning signal about the position of the user device 540 from the second ultra-wideband element 560b to the data modem 550, wherein the original positioning signal indicates the position of the user device 540 and is generated by the second ultra-wideband element 560b. In step S73, the data modem 550 converts the original positioning signal into the positioning information of open radio access network format.

In short, in steps S71 and S73, the data modem 550 may receive the original positioning signal about the position of the user device 540 through the first ultra-wideband element 560a, and converts the original positioning signal into the positioning information of open radio access network format, to make the second application receive the positioning information of open radio access network format (instead of other formats).

In addition, the first ultra-wideband element 560a may further generate the original positioning signal of the data modem 550. Therefore, in step S73, the data modem 550 may further convert the original positioning signal of the data modem 550 into the positioning information of open radio access network format, and the second application may receive the positioning information of both the user device 540 and the data modem 550, wherein the two pieces of positioning information are of open radio access network format.

Further, in this embodiment, the data modem 550 may be established with independent transmission channels with the service management and orchestration apparatus 510, the non-real-time radio access network intelligent controller 520 and/or the near-real-time radio access network intelligent controller 530, to transmit positioning information to corresponding second application.

In addition to transmitting the positioning information to the second application, the modem 550 may also transmit time delay and other auxiliary determination information (for example, hardware serial numbers of the user device 540, the data modem 550, the first ultra-wideband element 560a and the second ultra-wideband element 560b), statistical data (e.g., number of packets sent, packet transmission rate), status of other network interfaces such as WiFi or Bluetooth, etc.

In short, the difference in the operation method of the embodiments in FIG. 3 and FIG. 5 is that, in FIG. 3, the positioning information of the user device 340 is generated by the ultra-wideband element 350, and that the positioning information is output to the second application from the first application 301 of the user device 340; and in FIG. 5, the positioning information of the user device 540 is generated by the second ultra-wideband element 560b and is output to the data modem 550, and the data modem 550 outputs the positioning information to the second application through the first application 501 of the data modem 550. It should be noted that, in the embodiment in FIG. 5, the user device 540 is not limited to only communicate with the data modem 550, and the user device 540 may still be directly connected to one or more of the second applications 502a, 502b and 502c.

Please refer to FIG. 8 which is a block diagram of the auxiliary positioning system according to yet still another embodiment of the present disclosure. Since the auxiliary positioning system 800 illustrated in FIG. 8 is similar to the auxiliary positioning system 500 illustrated in FIG. 5, the repeated description is omitted herein. The difference between the auxiliary positioning system 800 in FIG. 8 and the auxiliary positioning system 500 in FIG. 5 is that, an open radio access network base station 870 is further illustrated in FIG. 8.

First, as shown in FIG. 8, the service management and orchestration apparatus 810 and the near-real-time radio access network intelligent controller 830 may be directly connected to the open radio access network base station 870, and the non-real-time radio access network intelligent controller 820 may be indirectly connected to the open radio access network base station 870. The open radio access network base station 870 may include a first unit 8701, a second unit 8702, a third unit 8703 and a fourth unit 8704. The first unit 8701 may be a base station (gNB/eNB), the second unit 8702 may be a radio unit (RU), the third unit 8703 may be a distributed unit (DU), and the fourth unit 8704 may be a central unit (CU).

In detail, the service management and orchestration apparatus 810 may be connected to the near-real-time radio access network intelligent controller 830 through the first interface I1, and may be connected to the open radio access network base station 870 through the second interface I2. The near-real-time radio access network intelligent controller 830 may be connected to the open radio access network base station 870 through the third interface I3. The first interface I1 may be an A1 interface of the open radio access network and is configured for communication between the non-real-time radio access network intelligent controller 820 and the near-real-time radio access network intelligent controller 830. The second interface I2 may be an O1 interface of the open radio access network, for example, a control interface of fault/configuration/accounting/performance/security (FCAPS). The third interface I3 may be an E2 interface (node) of the open radio access network and is configured for communication between the near-real-time radio access network intelligent controller 830 and the open radio access network base station 870.

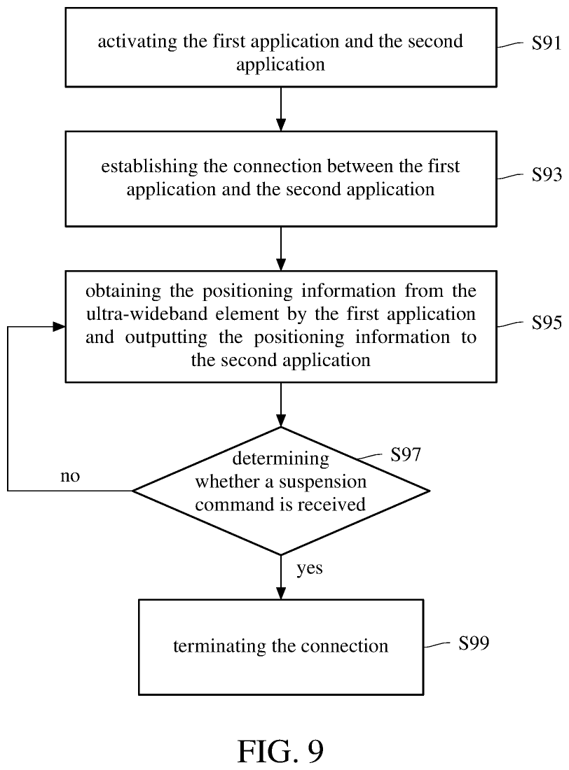

Please refer to FIG. 9 along with FIG. 8, wherein FIG. 9 is a flow chart of the method of applying the ultra-wideband element according to an embodiment of the present disclosure. As shown in FIG. 9, the method of applying the ultra-wideband element includes: step S91: activating the first application and the second application; step S93: establishing the connection between the first application and the second application; step S95: obtaining the positioning information from the ultra-wideband element by the first application and outputting the positioning information to the second application; step S97: determining whether a suspension command is received; if the determination result of step S97 is “Yes”, executing step S99: terminating the connection; and if the determination result of step S97 is “No”, executing step S95. For simplicity of description, the following description illustrates an example of the first application 801a of the data modem 850 and the second application 801b of the service management and orchestration apparatus 810.

In steps S91 and S93, the first application 801a and the second application 801b are activated, and the connection between the first application 801a and the second application 801b are established (for example, the transmission channel established according to the network configuration protocol).

In step S95, the first application 801a obtains the positioning information from the first ultra-wideband element 860a and outputs the positioning information to the second application 801b, wherein the first ultra-wideband element 860a may obtain the positioning information of the user device 840 through the second ultra-wideband element 860b and transmits the positioning information to the second application 801b.

In step S97, the data modem 850 may determine whether a suspension command is received from the service management and orchestration apparatus 810, wherein the suspension command instructs suspending the connection between the first application 801a and the second application 801b. For example, the service management and orchestration apparatus 810 may output the suspension command after determining collecting enough positioning information. The service management and orchestration apparatus 810 may also only collect the positioning information within a limited time period, and output the suspension command after determining collecting the positioning information within the limited time period. If determining receiving the suspension command, the data modem 850 may execute step S99 to suspend the connection between the first application 801a and the second application 801b; if determining not receiving the suspension command, the data modem 850 may execute step S95 to suspend the connection between the first application 801a and the second application 801b. The data modem 850 may execute step S95 at fixed or non-fixed time intervals after establishing the connection between the first application 801a and the second application 801b, and suspend the connection between the first application 801a and the second application 801b when triggered by the suspension command. In addition, the service management and orchestration apparatus 810 may re-establish the connection between the first application 801a and the second application 801b after suspending the connection between the first application 801a and the second application 801b.

In view of the above description, according to the auxiliary positioning system and method of one or more embodiment of this disclosure, the service management and orchestration apparatus, the non-real-time radio access network intelligent controller and/or the near-real-time radio access network intelligent controller can effectively improve the accuracy of 5G private network in indoor positioning based on the positioning information of the user device. Therefore, the service management and orchestration apparatus, the non-real-time radio access network intelligent controller and/or the near-real-time radio access network intelligent controller can adjust the software/hardware/firmware parameters of the base station according to the positioning information to further improve the wireless transmission performance between the base station and the user device (stability/delay/throughput, etc.). In addition, the service management and orchestration apparatus, the non-real-time radio access network intelligent controller and/or the near-real-time radio access network intelligent controller can adjust the software/hardware/firmware parameters of the base station according to the positioning information to further improve the 5G wireless transmission performance between the base station and the data modem. Also, since the data modem can transmit through Wi-Fi, the data modem can use positioning information to further improve the wireless transmission performance between the data modem and the user device (it may be Wi-Fi, Bluetooth or other wireless transmission technologies).

Although the present invention is disclosed in the foregoing embodiments, it is not intended to limit the present invention. Changes and modifications made without departing from the spirit and scope of the present invention belong to the scope of patent protection of the present invention. For the scope defined by the present invention, please refer to the attached claims.

What is claimed is:

1. An auxiliary positioning system comprising:
a service management and orchestration apparatus comprising a non-real-time radio access network intelligent controller;
a near-real-time radio access network intelligent controller connected to the service management and orchestration apparatus; and
an ultra-wideband element connected to a second application disposed at at least one of the service management and orchestration apparatus, the non-real-time radio access network intelligent controller and the near-real-time radio access network intelligent controller through a first application, and configured to output positioning information about a user device to the second application through the first application.

2. The auxiliary positioning system of claim 1, wherein the first application is installed on the user device, and the ultra-wideband element is disposed on the user device.

3. The auxiliary positioning system of claim 2, wherein the user device obtains an original positioning signal about a position of the user device from the ultra-wideband element, and converts the original positioning signal into the positioning information of an open radio access network format.

4. The auxiliary positioning system of claim 1, wherein the ultra-wideband element is a first ultra-wideband element, and the auxiliary positioning system further comprises:
a second ultra-wideband element connected to the first ultra-wideband element and disposed on the user device, and configured to output the positioning information to the first ultra-wideband element; and
a data modem connected to the first ultra-wideband element, wherein the first ultra-wideband element is disposed on the data modem, and the first application is installed on the data modem.

5. The auxiliary positioning system of claim 4, wherein the data modem obtains an original positioning signal about a position of the user device from the first ultra-wideband element, and converts the original positioning signal into the positioning information of an open radio access network format.

6. An auxiliary positioning method comprising:
connecting an ultra-wideband element to a second application disposed at at least one of a service management and orchestration apparatus, a non-real-time radio access network intelligent controller and a near-real-time radio access network intelligent controller through a first application; and
outputting positioning information about a user device to the second application through the first application by the ultra-wideband element.

7. The auxiliary positioning method of claim 6, wherein the first application is installed on the user device, and the ultra-wideband element is disposed on the user device.

8. The auxiliary positioning method of claim 7, wherein outputting the positioning information about the user device to the second application through the first application by the ultra-wideband element comprises:
detecting the user device by the ultra-wideband element to obtain an original positioning signal about a position of the user device and outputting the original positioning signal; and
converting the original positioning signal into the positioning information of an open radio access network format by the user device.

9. The auxiliary positioning method of claim 6, wherein the ultra-wideband element is a first ultra-wideband element and is disposed on a data modem, the first application is installed on the data modem, a second ultra-wideband element is disposed on the user device, and outputting the positioning information about the user device to the second application through the first application by the ultra-wideband element comprises:
receiving the positioning information from the second ultra-wideband element by the first ultra-wideband element;
obtaining the positioning information from the first ultra-wideband element by the data modem; and
outputting the positioning information through the first application by the data modem.

10. The auxiliary positioning method of claim 9, wherein outputting the positioning information about the user device to the second application through the first application by the ultra-wideband element further comprises:
outputting an original positioning signal about a position of the user device from the second ultra-wideband element to the data modem by the first ultra-wideband element; and
converting the original positioning signal into the positioning information of an open radio access network format by the data modem.
